(19) United States
(12) Patent Application Publication
(10) Pub. No.: US 2013/0077437 A1
(43) Pub. Date: Mar. 28, 2013

(54) METHOD AND SYSTEM FOR DETERMINING THE RIGIDITY OF A GEOLOGICAL LAYER

(71) Applicants: Francesco Mulargia, Bologna (IT); Silvia Castellaro, Venezia (IT); Mariapia Pastor, Bosco Chiesanuova (IT); Gianluca Vinco, Grezzana (IT)

(72) Inventors: Francesco Mulargia, Bologna (IT); Silvia Castellaro, Venezia (IT); Mariapia Pastor, Bosco Chiesanuova (IT); Gianluca Vinco, Grezzana (IT)

(73) Assignee: URETEK S.R.L., Bosco Chiesanuova (VR) (IT)

(21) Appl. No.: 13/700,260

(22) PCT Filed: May 27, 2011
(86) PCT No.: PCT/EP2011/058743

§ 371 Date: Nov. 27, 2012

(30) Foreign Application Priority Data
May 28, 2010 (EP) 10425184.8

(51) Int. Cl. G01V 1/48

(52) U.S. Cl. CPC G01V 1/48
USPC 367/31

(57) ABSTRACT

The present invention refers to a method for determining the rigidity of a geological layer in terms of propagation velocity of the elastic waves within a geological system delimited by a free surface (2) and comprising at least one first geological layer (6) having a second rigidity and a second geological layer (5) having a second rigidity and being arranged below the first geological layer, said first and second layer being separated from each other by an interface (3), the method comprising the steps of: positioning a source (4) suitable to generate seismic waves in the second geological layer (5), whose rigidity is intended to be measured; activating said source of seismic waves; detecting at least one seismic signal by means of at least one sensor arranged coupling with the free surface, and determining—from at least one seismic signal—a shear velocity of the elastic waves in the second layer and thus indicating the rigidity of the second layer. In a further aspect, the present invention refers to a system for determining the rigidity of a geological layer.

The present invention refers to a method and to a system for determining the rigidity of a geological layer underlying another geological layer, which is preferably a surface layer delimited at the upper part by a free surface. In particular, the invention refers to a method and system for determining the rigidity of a geological underlying a more rigid surface layer.

The measurement of the elastic properties, and in particular the rigidity, μ, of the geological layers on which building foundations and generally building structures lie or into which they are submerged, may have various applications, among which the evaluation of the stability of the subsoil and thus the risk of collapse or permanent deformation of a building structure in the long term and/or in the case of a seismic event.

The classification of foundation subsoils according to the NEHRP (USA), Eurocode 8 (Europe) and NTC2008 (Italy) standards for designing seismic-resistant structures is mainly based on the velocity of the shear waves of a homogeneous layer equivalent to the first thirty metres of depth, Vₛ₃₀. The velocities of the shear waves, Vₛ, is actually directly related to the rigidity of the material that forms the geological layer through the equation

μ=ρVₛ², (1)

where ρ is the density of the layer.

An application of the measurement of the velocity of the elastic waves in the subsoil is the evaluation of the efficiency of the interventions for consolidating the subsoil beneath existent foundations, aimed at improving the elastic parameters, such as the Young's modulus and the rigidity modulus.

Indirect techniques, based on surface measurements, i.e. neither inserting detector elements into the subsoil nor extracting samples from the subsoil and measuring their properties in a laboratory, are often used for measuring the velocity of the elastic waves. Typically, indirect techniques are of seismic type, i.e. they are based on the analysis of the seismic waves produced by an artificial source.

Conventional approaches for measuring the velocity of the seismic shear waves require a relatively high number of sensors, with ensuing increase of costs and the spaces required for the deployment as well as practical difficulties for their use in urban environments.

Furthermore, the use of the conventional method of seismic prospection and i.e. generating—by means of suitable apparatus—longitudinal P and transverse S body waves and recording their refraction by the geological layers, with the ensuing identification and measurement of the elastic properties of the latter, is inefficient. As a matter of fact, the physical law which governs refraction at an interface between two layers is the Snell's law

sin i/sin r=V1/V2, (2)

according to which the ratio between the sine of the angle of incidence i and the sine of the angle of refraction r is equal to the ratio between the velocity in the first and in the second layer. If the source and the detector elements are positioned on the surface and the velocity of the underlying layer is greater, i.e. V₁<V₂, upon reaching the critical angle of incidence according to which sin r=90°, the refracted wave travels parallel to the interface between the two layers and may be re-refracted in the surface layer, thus allowing to measure the velocities and the thicknesses of both layers. However, as it typically occurs in case of sub-foundation layers, if V₁>V₂, the body wave is not refracted parallel to the interface and shall not be re-refracted in the surface layer. Hence, it is impossible to measure, by detecting the refracted body waves, the velocity and the thickness of the underlying layer, which remains invisible and is referred to as a “ghost layer”.

Methods for exploring the subsoil based on the study of the dispersion of elastic surface waves have been developed recently. These allow using a lower number of sensors while maintaining the same accuracy. In general, the exploration depth of the surface waves is directly proportional to the wavelength: see e.g., C. B. Park et al. in “Multi-channel analysis of surface waves (MASW)” published in Geophysics, vol. 64, p. 800-808. 1999, who describe a multi-channel technique of surface wave analysis for determining the velocity profile of the shear waves.

In case of analysis techniques of surface waves, the source is an apparatus which generates both P waves and S waves. The interaction between these two types of waves in proximity to a surface gives rise, at a given distance from the source, to surface waves. Energisation is typically actuated by means of a hammer which hits—once or several times—metal plates coupled to the surface of the ground to be explored. In this manner, wavefronts are generated which propagate through the underlying ground.

Generally, the surface layer comprising the foundations of a building structure, indicated hereinafter also as foundation layer, typically has a rigidity greater than the rigidity of the underlying layer, which may be of different type (e.g. clay soil, sandy soil, etc).

The applicant observed that when investigating the elastic properties of a geological layer beneath the foundations, if the source is located on the surface of the ground to be explored, the energy developed by the source remains mostly trapped in the surface layer which serves as a waveguide for the elastic waves, due to the relatively high difference in seismic impedance between the two layers. Actually, through the interface between the surface layer and the underlying layer, only a fraction k of the incident energy is transmitted, while the remaining energy (1−k) is reflected. Calculating the value of the energy trapped in the layer and transmitted in terms of surface waves is generally complex and depends on the specific geometry of the problem. In first approximation, if the difference between the rigidity—i.e. the products of density by velocity squared, according to relation (1)—of the two layers is large only a small amount of energy is transmitted into the underlying layer and is available to explore it. The waves transmitted in the underlying layer are then retransmitted into surface, but the their energy is reduced at the interface between the two layers by a further factor of the order of k. In conclusion, by generating at the surface the waves to explore the underlying layer, and recording them at the surface, the energy of the waves that return to the surface after exploring the underlying layer is—in first approximation—reduced by a factor k². For example, a typical value of k is 0.2, thus the waves that have explored the underlying layer return to the surface with energy in the order of 0.04 and their identification among the waves that are trapped for reflection in the first layer (whose energy is much higher, in the order of 0.8) is practically impossible. Hence, the identification of the surface waves associated to the lower layer in the detected seismic traces and the measurement thereof are extremely difficult.

In the analysis of surface waves, the interaction between the P and S body waves gives rise of the surface waves. To analyse those waves, therefore both P and S waves therefore are to be generated simultaneously.

The Applicant has realised that if the active generator source of primary waves is positioned in the underlying layer whose rigidity is intended to be measured, the energy generated in the underlying layer is mostly available for characterizing the layer itself and is transmitted to the overlying layer solely after having “explored” the underlying one.

In particular, in case of energization in the underlying layer and in presence of an interface between two layers with different elastic properties with respect to each other (for example between two geological layers with different rigidity such as the foundation layer and the underlying layer), most of the energy is “trapped” in the underlying layer and it is represented by interface waves. These waves, called Stoneley waves, are entirely similar to Rayleigh surface waves and they propagate beneath the interface with the overlying layer with a simultaneously vertical and horizontal oscillation motion. Due to the continuity of displacements across the interface, the Stoneley waves extend also into the upper layer, exciting—by continuity—both the horizontal and vertical motions, but exponentially attenuating when moving away from the interface itself. More specifically, the waves whose frequency coincides with one of the vibration modes of the Rayleigh waves and of the Love waves in the overlying layer shall be the least attenuated among the transmitted waves. The latter shall appear on the surface with more energy. In any case, given that only a fraction of energy is transmitted to the interface, to be detected on the surface, they should be generated with enough energy to be recorded. In particular, the detected waves are those that return to the surface after having explored the lower layer and having crossed the interface between lower and upper layer.

The Applicant has understood that by positioning the source of seismic waves in the layer whose rigidity is intended to be measured it is possible to detect at the surface the Stoneley waves, that occur at the surface as Rayleigh and Love surface waves modes. In particular, the Stoneley waves appear at the surface as higher modes of surface waves of Rayleigh and Love.

In an aspect, the present invention refers to a method for determining the rigidity of a geological layer in terms of propagation velocity of the elastic waves within a geological system delimited by a free surface and comprising at least one first geological layer having a first rigidity and a second geological layer having a second rigidity and being arranged below the first geological layer, said first and second layer being separated from each other by an interface, the method comprising the steps of:
positioning a source apt to generate seismic waves within the second geological layer, whose rigidity is intended to be measured;
activating said source of seismic waves;
detecting at least one seismic signal by means of at least one sensor arranged coupled with the free surface, and
determining from at least one seismic signal a shear velocity of the elastic waves in the second layer and thus indicative of the rigidity of the second layer.

Preferably, in the method, the step of determining a shear velocity of the elastic waves in the second layer comprises the following steps:
determining from at least one seismic signal the propagation velocity of surface waves caused by the seismic waves generated by said source;
determining a map of said propagation velocities of the surface waves as a function of the frequency thereof;
identifying, in the velocities map, a propagation velocity whose frequency is correlated to a depth in the geological system, and
correlating at least one propagation velocity identified in the velocities map to a shear velocity of the elastic waves in the second layer and thus indicative of the rigidity of the second layer.

Preferably, the method comprises the step of calculating the rigidity from the shear velocity of the elastic waves in the second layer.

Preferably, the rigidity value of the first layer is greater than the rigidity value of the second layer.

Preferably, the first geological layer is delimited by the free surface and comprises the foundations of a building structure.

Preferably, the first layer has a thickness and the source is positioned at a depth with respect to the free surface larger than the thickness of the first layer.

Preferably, the source of seismic signal is an impulsive source suitable to generate body waves.

Preferably, in the method, the step of detecting at least one seismic signal comprises detecting a plurality of seismic signals and it is obtained by means of an array of sensors comprising a plurality of sensors arranged coupled with the free surface, each sensor being apt to detect a seismic signal of the plurality of seismic signals. Preferably, the surface waves whose propagation velocity is detected are detected through a multichannel technique.

Preferably, the step of detecting at least one seismic signal comprises detecting a signal as a function of the time during a period of acquisition and the step of determining a map of the propagation velocity of the surface waves comprises performing a transformation of the seismic signal from the time domain to the frequency domain.

In a further aspect, the present invention refers to a system for determining the rigidity of a geological layer in terns of propagation velocity of the elastic waves within a geological system delimited by a free surface and comprising at least one first geological layer having a first rigidity and a second geological layer having a second rigidity and being arranged below the first geological layer, said layers being separated from each other by an interface, the system comprising

a source suitable to generate seismic waves;

at least one seismic signal sensor arranged coupled with the free surface, and

an electronic unit for acquiring seismic signals detected by the at least one sensor, wherein said source is positioned in the second geological layer.

Preferably, the at least one seismic signal sensor is an array of seismic signal sensors comprising a plurality of sensors, the plurality including a first and a last sensor, arranged coupled with the free surface at a predetermined spacing form each other. Preferably, the sensors are aligned along an alignment direction and the source is positioned at a predetermined distance from the first sensor of the linear array of sensors, defined along the alignment direction.

Preferably, the source is positioned in the second layer at a depth comprised between 0.1 m and 2.0 m from the interface con the first layer.

Preferably, the source of seismic waves is energized by a depth seismic gun.

The present invention shall be described hereinafter more in detail with reference to the attached drawings, in which some but not all the embodiments are shown. The drawings illustrating the embodiments are schematic representations.

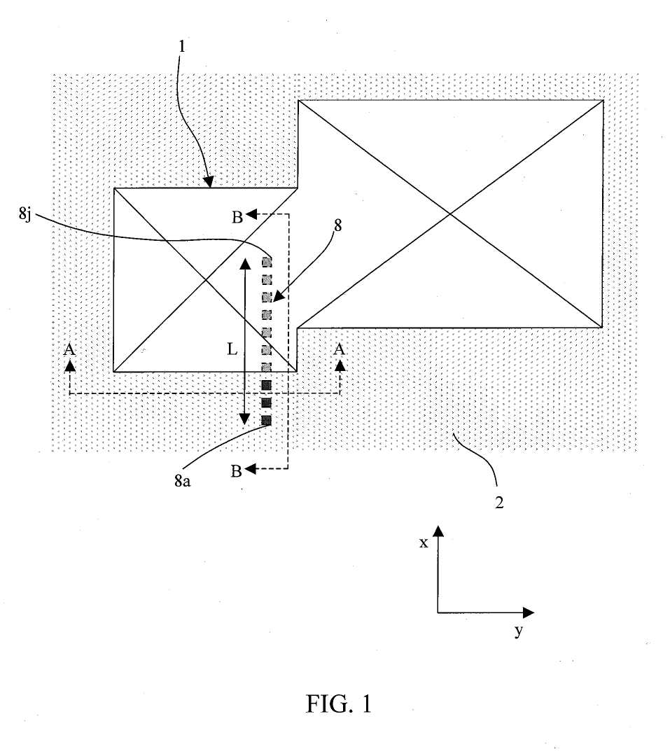

FIG. 1 represents a planar view illustrating an exemplifying arrangement of an array of sensors apt to measure the elastic properties of the subsoil beneath and/or in proximity to a building, according to an embodiment of the invention.

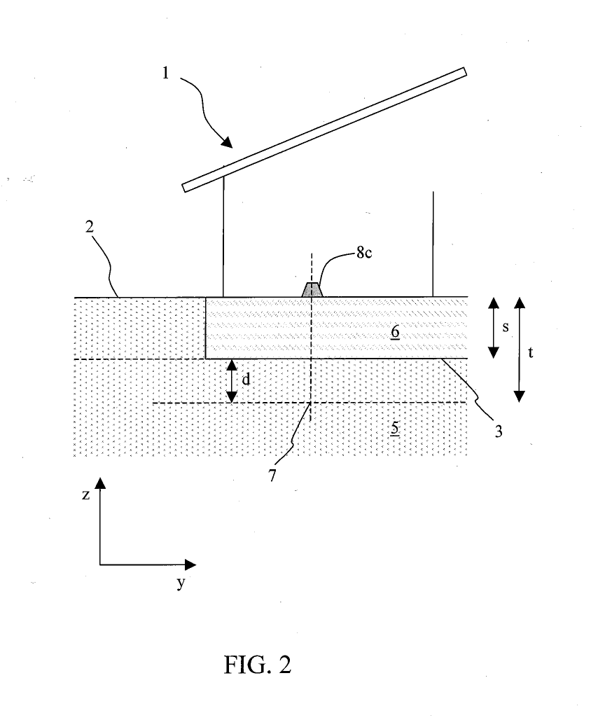

FIG. 2 represents a first cross section of FIG. 1 along line AA.

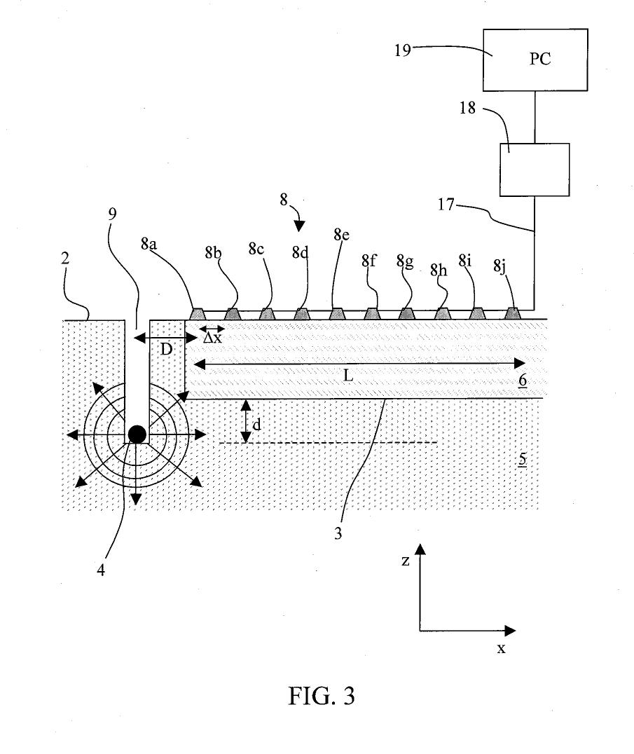

FIG. 3 represents a second cross section of FIG. 1 along line BB. With the aim of improving clarity, the representation of the building 1 is omitted in the figure.

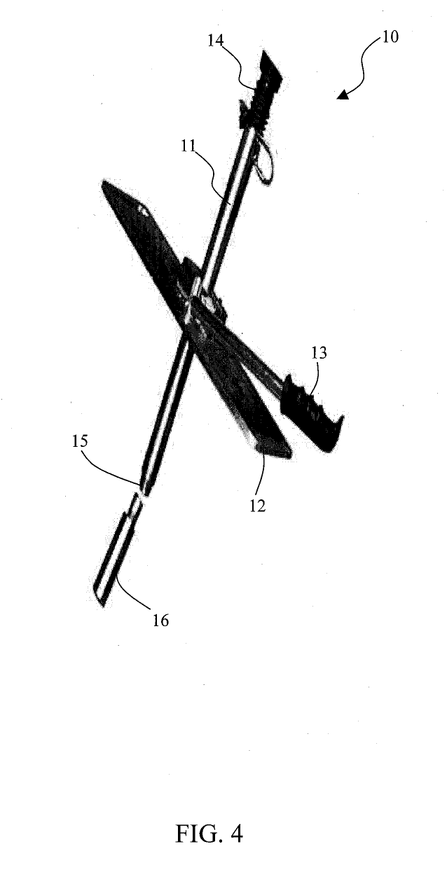

FIG. 4 schematically shows the structure of a seismic gun which can be used for the implementation of the method according to the present invention.

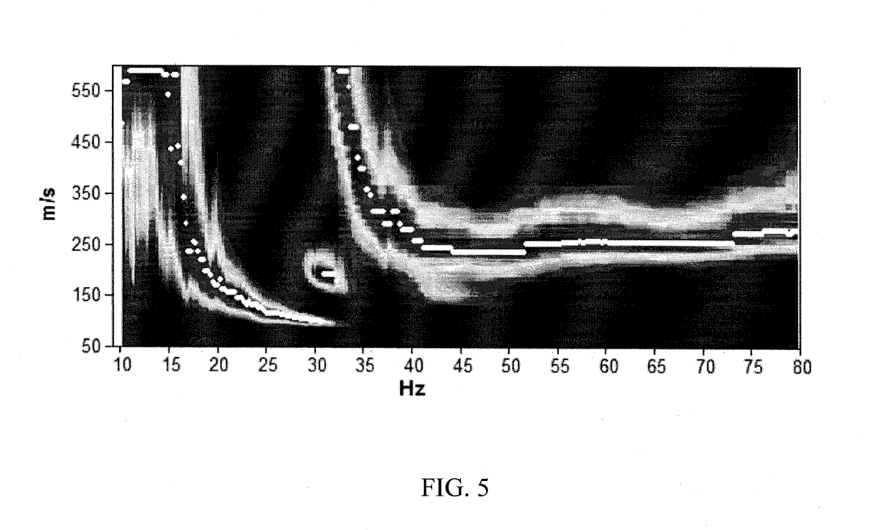

FIG. 5 is an example of an image of the phase velocity of the surface waves (Love) as a function of the frequency in a situation prior to the intervention of consolidating the layer underlying the foundations.

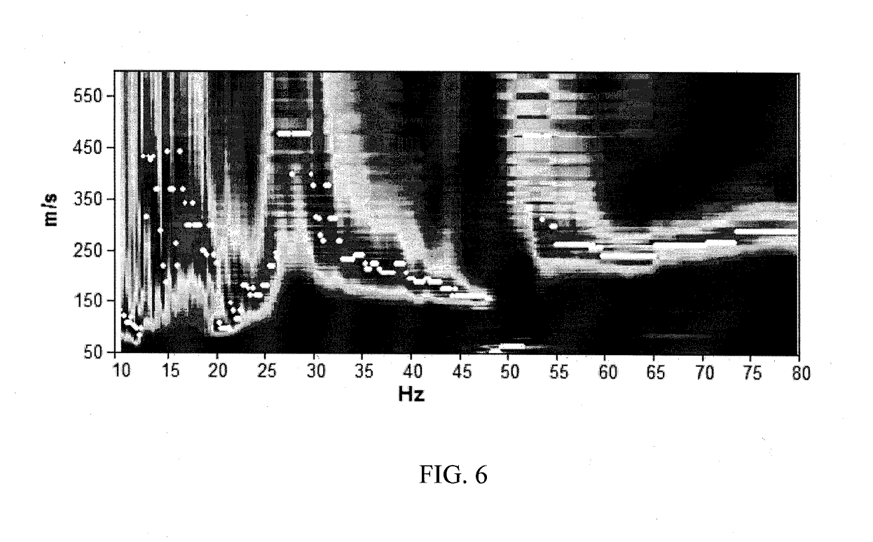

FIG. 6 is an example of an image of the phase velocity of the surface waves (Love) as a function of the frequency in a situation subsequent to the intervention of consolidating the layer underlying the foundations.

Referring to FIGS. 1 to 3, in a preferred embodiment, the present invention refers to a method and to a system for measuring the rigidity of a geological layer positioned beneath the foundations of buildings and building structures in general, which constitute or are included in a surface layer delimited at the upper part by the free surface of the ground and indicated as foundation layer. The characterisation of the geological layers according to the method and system according to the present preferred embodiment may be performed both before a ground consolidation intervention and after the intervention with the aim of evaluating the effectiveness of intervention itself.

In the first approximation, it is possible to describe the subsoil as a stratified medium wherein the main variation of the composition and of the mechanical properties occurs along the depth, while the variation in the two horizontal directions is negligible. In this context and according to a non-limiting convention of the present invention, the layers are defined starting from the surface: the first layer shall be the surface one, the second shall be the underlying one and so on and so forth.

The method according to a particular aspect of the present invention is apt to measure the velocity of the elastic waves in a geological system comprising at least one first layer of the subsoil 6 and a second geological layer 5 underlying with respect thereto. The first layer is that whose upper surface is the free surface 2. The interface between the upper layer (first) 6 and the lower layer (second) 5 is indicated with reference number 3.

In the embodiment illustrated in FIGS. 1-3, the first geological layer 6 is a foundation layer comprising the foundations of a building structure, for example a residential building 1.

The system for measuring the elastic waves which are propagated in the geological system comprises a source 4 (shown in FIG. 3) apt to generate elastic body waves and an array of sensors 8 comprising a plurality of sensors 8a, 8b, . . . , 8j, each of which being apt to detect elastic surface waves which propagate along the free surface 2 of the ground. Preferably, the array of sensors is a linear array in which the sensors are arranged in line at a given spacing between a sensor and the next adjacent sensor (FIG. 3). In the example illustrated in FIGS. 1-3 the array of sensors is constituted by ten sensors with constant spacing Δx.

However, the number of sensors comprised in the illustrated array shall not be deemed to be !imitative of the present invention, such number being selected depending on the applications, for example as a function of the length of the area to be explored, as described further in detail hereinafter. In this context, a plurality of sensors is to be intended comprising at least two sensors, preferably between 4 and 12 sensors.

In a different embodiment, the spacing between the sensors may be of a different value from one sensor to another sensor or generally be non-constant.

According to a main aspect of the preferred embodiments of the present invention, the method is apt to measure the surface waves produced by primary and secondary waves generated by a source located within a second geological layer underlying a first geological layer, the source being positioned at a predetermined depth greater than the thickness of the first layer, e.g. the foundation layer. In particular, the method is apt to measure, at the surface, the surface waves produced by the Stoneley interface waves.

Referring to FIGS. 1-3 and called s the thickness of the first layer 6 (FIG. 2, along the z-axis), the source is located at a depth t>s. In a preferred embodiment, the distance d from the interface 3 between the first and the second geological layer, i.e. d=t−s, is comprised between 0.5 m and 1.5 m.

Preferably, the source is an impulsive seismic source and comprises at least one explosive charge with initial velocity comprised between 300 and 700 m/s. In a preferred embodiment, the source comprises an explosive charge with an initial velocity of 500 m/s and insertion time <1 ms.

In some embodiments, the source 4 is positioned at a depth t, greater than the thickness s of the foundation layer, within a hole 9 (indicated in FIG. 3) which extends from the free surface through the geological system. In FIG. 2, the position of the source 4 along the z-axis (depth) is indicated with 7.

The source is apt to generate interface and surface seismic waves.

In a preferred embodiment, the energization of the source is provided by means of a depth seismic gun, schematically illustrated in FIG. 4 and indicated in its entirety with reference number 10. The seismic gun has been particularly designed to operate at a greater depth than normal seismic guns. The depth seismic gun comprises a barrel 11, of length suitable to reach the depth t, the barrel being inserted into the ground, inside the lower geological layer (or reaching the lower layer), into a previously made hole (e.g. hole 9 in FIG. 3). For example, the length of the barrel 11 of the seismic gun is at least 2 metres long, for example comprised between 2 and 3 metres, so as to be able to position and detonate the explosive charge, i.e. a cartridge, inside the underlying layer. The gun comprises a plate 12 for laying on the ground surface, a support knob 13 and a trigger knob 14. The end 15 of the barrel 11 is engaged to a removable explosion chamber 16, with open bottom, into which the cartridge of the industrial type, per se known and available in the market, is inserted. The explosion of the cartridge may be performed by the free surface, by operating on the trigger knob 14 which mechanically hits an ignitor (not shown in the figure), generating the explosion of the cartridge, by means of a device (not shown in the figure) extending along the barrel 11.

Preferably, the sensors of the array of sensors 8 are geophones, i.e. elastic waves electromechanical transducers.

The signal of each geophone 8a, . . . , 8j is recorded separately but synchronously on the different geophones. A relation between the wavelength and the thickness of the explored layer holds for the surface waves and for the layer waves. Generally, the components with large wavelength, λ, provide information regarding layers with greater depths, while components with small wavelength λ provide information regarding layers closer to the surface. The relation:

V=λ·f (3)

holds, where V is the velocity of the waves and f the frequency thereof. Considering the same velocity, the components with large wavelength λ are the low frequency ones and those with small wavelength λ are the high frequency ones.

Preferably, each sensor 8a, 8b, . . . , 8j is a geophone with frequency comprised between 4 and 10 Hz. In an embodiment, the geophones 8a, . . . , 8j of the array 8 are horizontal motion geophones, suitable for detecting the velocity of the surface waves with transverse horizontal polarisation, i.e. Love waves. In a further embodiment the geophones are vertical motion geophones, suitable for detecting the velocity of the Rayleigh waves.

In the embodiment illustrated in the figures and with particular reference to FIG. 3, the measuring method comprises the generation of a shot “outside” the sensors line, i.e. the source is arranged at a predetermined distance D, defined along the direction of arrangement of the sensors (x-axis), from the nearest sensor, i.e. first sensor 8a, of the array. Preferably, with the aim of reducing or minimising the effects of the near field, D is not smaller than 5 m, more preferably it is comprised between 6 and 20 m.

Preferably, the array of sensors is linear along an aligning direction (axis x) and the source is arranged on the extension of the sensors alignment. However, in some embodiments of the present invention, the source is not arranged aligned with the array of sensors, but it is slightly displaced with respect to the aligning position in the plane (y,z), indicated with reference number 7 in FIG. 2.

In a further embodiment (not shown in the figures), the array of sensors is developed according to a two-dimensional geometry, such as for example according to an X, T or L-shaped arrangement. The minimum spacing between the sensors is in relation with the minimum detectable wavelength, thus with the detectable minimum depth. Preferably, the minimum spacing is comprised between 0.5 and 2 m.

In an embodiment, the sensors of the array of sensors are equally spaced from each other, with spacing Δx between 0.5 and 2 m.

The distance between the first and the last sensor of the array, referred to as the detection length and indicated with L, represents the length of the detection coverage of the system and it is in relation with the maximum wavelength, thus with the maximum detectable depth.

The step of recording the surface waves is carried out according to the multi-channel analysis of surface waves (MASW) technique. According to this technique, the recording of the surface waves generated by the seismic source by the plurality of receivers occurs simultaneously. The sensors are typically coupled to the soil by means of rods while on floors/foundations tripods are used. Referring to FIG. 3, the sensors 8a, 8b, . . . , 8j, synchronised in acquisition, are connected, through a connection line 17, to a data acquisition line 18, preferably a digital multichannel seismograph with a number of channels at least equal to the number of sensors, which may be a commercial seismograph (e.g. Rosina produced by Micromed spa). The data acquisition unit may comprise or may in turn be connected with a central processing unit 19, for example a personal computer (PC). The acquisition of seismic traces occurs starting from the exceedance of a preset threshold (“trigger”, coinciding with the instant of energization of the subsoil) and it lasts for a few seconds after said event. In an embodiment, the data acquisition unit saves the data regarding a brief period preceding the exceeding of the threshold (“pre-trigger”), said period lasting a few seconds or a few fractions of a second preceding the instant when the threshold is exceeded.

During the period of data acquisition by the data acquisition unit, the seismic traces are recorded by each sensor as a function of the time, thus obtaining a plurality of amplitude/time signals, each signal being detected by the respective sensor of the array of sensors.

Phase velocity spectra of the surface waves and the respective experimental dispersion curves are obtained through a transformation from the amplitude/time domain to the wave frequency/number domain (f−k) or slowness/frequency domain (p−f), or to the velocity/frequency domain (V−f), according to the processing methods known in the MASW field technique. Such technique is generally efficient at isolating the surface waves from the body waves (P and S), the first generally constituting the main portion of the seismic trace in presence of a sufficiently far energization, e.g. of a source located sufficiently far from the sensor array. A dispersion curve is calculated by searching the maximum values of spectral power in the space f−k or p−f, so as to form a 2D image of the phase velocity of the Rayleigh and/or Love waves as a function of the frequency, which is in turn linked to the depth.

In particular and according to an embodiment, after recording the seismic traces, the step of determining the velocity of the surface waves comprises the following steps:

1) a test velocity value is hypothesised (Vi),

2) the traces to the different geophones, i.e. recorded by the different geophones, are time translated by an amount (Δt), which is determined by the ratio between the distance of each geophone from the source and the hypothesized velocity Vᵢ,

3) the traces thus translated in time are summed, so as to calculate the function of correlation of all the traces,

4) a transformation of the correlated signal in the frequency domain is carried out. The spectra maxima shall indicate the frequency of the phases that have travelled at the velocity Vᵢ.

Carrying out steps 1)-4) for different test velocities produces a data matrix which is represented in a two-dimensional plot frequency-Vᵢ, generally represented coloured, where the colours are proportional to the power spectra under step 4). The higher the power spectral density for a given pair of velocity and frequency, the higher the energy of the waves.

The maximum values in the spectral plots indicate the velocity at the various frequencies of the different propagation modes of surface waves, i.e. fundamental or higher-order modes, excited by the Stoneley waves, which thus appear as surface waves, both Rayleigh and Love surface waves. In other words, the Stoneley waves appear at the surface as surface waves of both Rayleigh and Love type.

In practice, what happens is that the Stoneley waves, travelling in the interface between the underlying layer and the overlying one, couple with the surface waves of the same frequency, providing energy thereto. It is these surface waves with “increased energy” that are recorded in surface and provide information on the Stoneley waves and thus on the underlying layer.

The variation of the velocity as a function of the frequency is called dispersion.

In an embodiment, the step of determining a shear velocity of the elastic waves in the second layer comprises the following steps:
determining from at least one seismic signal the propagation velocity of the Rayleigh and Love surface waves coupled to the interface (Stoneley) waves, the surface and interface waves being caused by the seismic waves generated by the source;
determining a map of said propagation velocities of the surface and interface waves as a function of their frequency;
identifying, in the velocities map, a propagation velocity whose frequency is correlated to a depth in the geological system, and
correlating at least one propagation velocity identified in the velocities map to a shear velocity of the elastic waves in the second layer and thus indicative of the rigidity of the second layer.

In an embodiment, the at least one seismic signal comprises detecting a plurality of seismic signals and it is obtained by means of an array of sensors comprising a plurality of sensors arranged coupled with the free surface, each sensor being apt to detect a seismic signal of the plurality of seismic signals and the step of detecting the plurality of seismic signals comprises positioning the array of sensors on the free surface and the step of determining the propagation velocity comprises determining, from the plurality of seismic signals, the propagation velocity of Rayleigh and Love surface waves coupled to the interface Stoneley waves.

FIG. 5 is an exemplifying image of experimental dispersion, in the phase frequency-velocity domain, obtained from the analysis of the seismic traces measured in a geological system of two layers, in which the upper layer is constituted by the foundations and has a thickness s of 1.3 m. The conditions of the experiment to which FIG. 5 refers were: an array of 10 horizontal component geophones with a vibrational frequency of 4.5 Hz arranged at a constant distance of 0.9 m from each other; an active source comprising a calibre 8 seismic gun with exploding industrial cartridge which develops a pressure of about 1700 bars and an initial gas velocity of 500 m/s, in which the cartridge was exploded at a depth t of about 2 m and a distance D of 15 m from the first geophone of the array; the sampling of the signals was performed at a frequency of 1024 Hz.

In FIG. 5, two distinct high energy regions are visible (in the grey scale, the greater energy corresponds to a lighter tonality), which are substantially attributable to two dominant modes of propagation of the surface waves, Love waves in this case: a first low frequency region extended from about 20 to 30 Hz (where there is a high density of maximum energy points, represented by white circles) and a second high frequency region which is extended approximately from 35 to 80 Hz. From the maximum energy points in each region there follows the identification of dispersion curves which indicate at what phase velocity the maximum transport of energy of the Love waves occurs as a function of frequency and thus of the explored depth. In particular, the first region is attributable to a first mode of the Love waves with a phase velocity of about 150 m/s and the second region is attributable to a second Love mode with a phase velocity of about 300 m/s.

After the detection reported in FIG. 5, an intervention for consolidating the layer underlying the surface foundation layer was carried out. The consolidation intervention may occur for example by providing a plurality of holes through the layer of the ground to be consolidated (i.e. the lower layer 5) and subsequently injecting an expanded resin for filling the holes, according to known techniques.

FIG. 6 is the dispersion image obtained from recording the seismic traces after the consolidation intervention. FIG. 6 shows the creation of a “channel” in which the waves not present in FIG. 5 travel, at a frequency between 30 and 45 Hz, i.e. an increase of rigidity in the layer in which the waves travel in this frequency range. As a matter of fact, it is observed that the maximum energy transfers both of the first and the second region are moved towards higher frequencies and velocities, with respect to the regions of maximum transfer of energy of FIG. 5. The points of maximum spectral power (white circles) for the first region extend now approximately from 30 to 45 Hz with phase velocity of about 200 m/s, while the points of maximum spectral power for the second region extend from about 55 to 100 Hz, with velocity of about 300 m/s. From a comparison of the image of FIG. 6 with an image of FIG. 5 it is concluded that the phase velocity for the first mode of the Love waves, associated with the deepest layer, is increased by about 30%. Both the velocity of the Rayleigh and Love surface waves is very close to that of the shear waves S, therefore the velocity value measured through the aforedescribed method represents, with good approximation, the value of the shear velocity Vs.

It is thus derived that the consolidation intervention has caused an increase of the shear velocity, in the lower layer, by about 30%.

The so-called inversion process allows to obtain a theoretical dispersion curve almost similar to the experimental dispersion curve, according to algorithms, per se known, for modelling of surface waves in multilayer systems. The calculation procedure thus allows to obtain, the profile of shear velocity, Vs, as a function of the depth, z. From the determination of the profile of shear velocity Vₛ(z) the rigidity of the ground is obtained, and in particular the rigidity of layer underlying the foundations, μ, given by the relation (1).

1. Method for determining the rigidity of a geological layer in terms of propagation velocity of the elastic waves within a geological system delimited by a free surface and comprising at least one first geological layer having a first rigidity and a thickness and a second geological layer having a second rigidity and being arranged below the first geological layer, said first and second layer being separated from each other by an interface, the method comprising the steps of:
positioning a source apt to generate seismic waves within the second geological layer, whose rigidity is intended to be measured;
activating said source of seismic waves;
detecting at least one seismic signal by means of at least one sensor arranged coupled with the free surface;
determining from at least one seismic signal a shear velocity of the elastic waves in the second layer and thus indicative of the rigidity of the second layer, and
calculating the rigidity from the shear velocity of the elastic waves in the second layer,
wherein
said source is positioned at a depth with respect to the free surface larger than the thickness of the first layer.

2. Method according to claim 1, wherein the step of determining a shear velocity of the elastic waves in the second layer comprises the following steps:
determining from at least one seismic signal the propagation velocity of surface waves caused by the seismic waves generated by said source;
determining a map of said propagation velocities of the surface waves as a function of the frequency thereof;
identifying, in the velocities map, a propagation velocity whose frequency is correlated to a depth in the geological system, and
correlating at least one propagation velocity identified in the velocities map to a shear velocity of the elastic waves in the second layer and thus indicative of the rigidity of the second layer.

3. Method according to claim 1, wherein the rigidity value of the first layer is greater than the rigidity value of the second layer.

4. Method according to claim 1, wherein the first geological layer is delimited by the free surface and comprises the foundations of a building structure.

5. Method according to claim 1, wherein said source of seismic signal is an impulsive source capable of generating body waves.

6. Method according to claim 1, wherein the step of detecting at least one seismic signal comprises detecting a plurality of seismic signals and it is obtained by means of an array of sensors comprising a plurality of sensors arranged coupled with the free surface, each sensor being capable of detecting a seismic signal of the plurality of seismic signals.

7. Method according to claim 2, wherein the step of detecting at least one seismic signal comprises detecting a plurality of seismic signals and it is obtained by means of an array of sensors comprising a plurality of sensors arranged coupled with the free surface, each sensor being capable of detecting a seismic signal of the plurality of seismic signals, and wherein the step of detecting the plurality of seismic signals comprises positioning the array of sensors on the free surface and the step of determining the propagation velocity comprises determining, from the plurality of seismic signals, the propagation velocity of Rayleigh and Love surface waves coupled to the interface Stoneley waves.

8. Method according to claim 6, wherein the surface waves whose propagation velocity is detected are detected through a multichannel technique.

9. Method according to claim 2, wherein the step of detecting at least one seismic signal comprises detecting a signal as a function of the time during a period of acquisition and the step of determining a map of the propagation velocity of the surface waves comprises performing a transformation of the seismic signal from the time domain to the frequency domain.

10. System for determining the rigidity of a geological layer in terms of propagation velocity of the elastic waves within a geological system delimited by a free surface and comprising at least one first geological layer having a first rigidity and a second geological layer having a second rigidity and being arranged below the first geological layer, said layers being separated from each other by an interface, the system comprising
a source suitable to generate seismic waves;
at least one seismic signal sensor arranged coupled with the free surface, and
an electronic unit for acquiring seismic signals detected by the at least one sensor, wherein said source is positioned in the second geological layer.

11. System according to claim 10, wherein the at least one seismic signal sensor is an array of seismic signal sensors comprising a plurality of sensors, the plurality including a first and a last sensor, arranged coupled with the free surface at a predetermined spacing from each other.

12. System according to claim 10, wherein the at least one seismic signal sensor is an array of seismic signal sensors comprising a plurality of sensors, the plurality including a first and a last sensor, arranged coupled with the free surface at a predetermined spacing from each other, and wherein the sensors are aligned along an alignment direction and the source is positioned at a predetermined distance from the first sensor of the linear array of sensors, defined along the alignment direction.

13. System according to claim 10, wherein said source is positioned in the second layer at a depth comprised between 0.1 m and 2.0 m from the interface con the first layer.

14. System according to claim 10, wherein the source of seismic waves is energized by a depth seismic gun.
